(19) United States
(12) Patent Application Publication
(10) Pub. No.: US 2015/0317749 A1
(43) Pub. Date: Nov. 5, 2015

(54) System and Method for Characterizing Financial Messages

(71) Applicant: Features Analytics SA, Nivelles (BE)

(72) Inventor: Cristina Soviany, Oversijse (BE)

(21) Appl. No.: 14/799,908

(22) Filed: Jul. 15, 2015

Related U.S. Application Data
(63) Continuation-in-part of application No. PCT/EP2014/050940, filed on Jan. 17, 2014.

(51) Int. Cl. G06Q 40/00; G06F 17/30

(52) U.S. Cl. CPC G06Q 40/12; G06F 17/30312; G06F 17/30598

(57) ABSTRACT

A system for characterizing financial messages having a plurality of data fields. A data integration unit selects data fields of the financial message and stores the selected data items as representation parameters in memory. At least one characterization unit characterizes a subset of representation parameters by scoring the financial message and assigning the selected subset of representation parameters to at least a first characterization parameter. The characterisation unit also assigns at least a first confidence value to the at least a first characterization parameter. At least one decision unit compares the first confidence value with a first threshold value.

### CROSS-REFERENCE TO RELATED APPLICATIONS

This application is a continuation-in-part application of international patent application No. PCT/EP2014/050940 “System and method for characterizing financial messages” filed on Jan. 17, 2014 and claiming the benefit of the filing of U.S. Provisional Patent Application Ser. No. 61/754,682, filed on Jan. 21, 2013.

The aforementioned patent applications are hereby incorporated by reference in their entirety.

### BACKGROUND OF THE INVENTION

1. Field of the Invention

This field of the present application relates in general to a system and method for characterizing financial messages, and in particular relates to evaluating fraud risk in electronic data processing systems for financial data.

The field of the present application further relates to characterizing financial transactions, such as personal loans and home loans, trading, virtual currency and payment related messages including authorization and notification and as well as for the detection of financial crimes such as money laundering, employee fraud and market abuse.

2. Brief Description of the Related Art

Fraud is one of the major issues in the financial industry, especially in respect to card payment systems, such as payments by credit card, as well as other forms of electronic payment systems. Fraud in this context means obtaining services/goods and/or cash by unethical and illegal means. Electronic payment systems require high-speed verification and authentication mechanisms that allow legitimate users easy access to conduct their business, while preventing fraudulent transaction attempts by others. Fraud detection is therefore essential in maintaining the viability of the financial system on a national and global scale, and to ensure that losses due to fraud are kept at a low level.

Two approaches are known in general for the characterising of financial messages in such systems, in particular for fraud detection systems, and these can be distinguished in general: Rule-based systems and Statistical systems. Rule-based systems use business or inference rules applied to the input data records in order to identify fraudulent behaviour. Statistical systems include statistical pattern recognition and neural networks technologies. Theoretically neural networks would provide the best solution to any problem, but practically the time to find the best solution is indefinitely long. Statistical pattern recognition is based either on a priori knowledge of the system or on statistical information extracted from deriving patterns from training sets. Statistical pattern recognition systems use statistical characterizations of features and patterns to characterise the information in the input data records for the financial messages and thus detect and predict abnormalities in the information. Compared to systems based on neural networks, statistical pattern recognition based systems have the ability to find an optimized solution in a shorter time.

From U.S. Pat. No. 7,865,427 B2 a method for evaluating risk in an electronic commerce transaction is known that provides a representation of the fraud risk to a merchant. The method of US '427 comprises the generating and storing of two or more fraudulent risk mathematical models. Each of the fraudulent risk mathematical models has a corresponding distribution of fraudulent transactions and a distribution of non-fraudulent transactions. The mathematical model receives real transaction information that has been manually characterised and applies the received transaction information to the two or more fraudulent risk mathematical models for producing a corresponding raw score. The two or more raw scores are then transformed into a single risk estimate.

U.S. Pat. No. 7,668,769 (Baker et al, assigned to Basepoint Technologies) teaches a computerised method of detecting fraud in financial transaction data, such as payment card transaction data. One embodiment described is the receipt of data records associated with a financial transaction and at least one so-called transacting entity, applying the data records to at least one model, generating a score based on the first model and generating data indicative of fraud in the financial transaction based at least partly on that score.

Statistical pattern recognition based fraud detection systems, as well as neural network based fraud detection systems, need a certain number of data records in a training set in order to provide an acceptable error rate, i.e. without too many false positives or false negatives. A verification set of data records is also required. Prior art fraud detection models need typically an equivalent of eight to fourteen months of training data to produce a fraud detection rate of 75%. The present disclosure teaches the deployment of a risk evaluation model that uses less data (over the same time scale) to train the system—and can thus be trained faster. This means that the system of the present disclosure can be deployed faster.

### SUMMARY OF THE INVENTION

This present disclosure relates to a system for characterizing financial messages by assigning the financial messages to at least a characterisation parameter. The financial messages comprise a plurality of input fields used in determining the characterisation parameter.

The characterizing system in one aspect of the disclosure comprises at least one data source providing the financial messages to a data integration unit. The data integration unit selects one or more of the input fields of the financial data records and stores the selected input field(s) in memory.

At least one characterization unit uses a subset of the input fields to assign at least a first characterization parameter to the financial data record and assigns at least a first confidence value to the at least a first characterization parameter as a result of the characterization. The subset of the input data used is not limited to particular types of input data, but can use any items of the input data and/or combinations thereof.

At least one decision unit compares the first confidence value with a first threshold value and assigns the financial messages to a characterisation category as a result of the comparison.

The confidence level assigned to the characterisation parameter allows evaluating the risk that the decision of the characterisation parameter is wrong, i.e. the presented financial data record has been assigned a false characterizing category. This enables a reduction in the number of false positives and false negatives in the characterisation procedure. The reduction enables a faster processing of the financial data records and a reduction in the amount of store required for those financial data records that need to be handled differently due to their characterisation parameters.

For example, one of the characterisation parameters may be whether the financial transaction represented by the financial message should be labelled fraudulent or not. If too many incorrect values for the characterisation parameters (i.e. too many false positives or too many false negatives) are identified then a large amount of extra storage space is required and also significant extra computing resources (as well as manual resources) will be required to investigate the veracity of the financial data record incorrectly identified as being fraudulent. In addition more analysts may be required to investigate the validity of the financial messages that will be further wasteful of resources. The system may include a plurality of characterising units. The characterising units will have different data models and their results can be combined to produce an overall characterisation parameter.

In another aspect of the present disclosure the system for characterizing financial messages comprises further a data-enhancing unit. The data enhancing using is able to create derived fields as a mathematical transformation of one or more input fields of the input data. Such mathematical transformations include, but are not limited to, logarithmic transformation, averaging transformation, determining reaching threshold values, as well as aggregating data to identify trends. A data scientist may identify that there are combinations of the input fields that enable more efficient and accurate characterisation of the financial messages. This would enable, for example, the financial messages to be processed more quickly and with less use of computing resources, as noted above.

In another aspect of the present disclosure, the data-enhancing unit can store over long term selected items of the input fields (or the derived fields) from the financial messages as historic fields. The data-enhancing unit is able to create one or more historic fields based on the stored fields. These items of historic fields can be used to better characterise the financial message.

The data-enhancing unit selects a subset of the data fields received from the data sources and stores this subset of the data fields in a database. The time limit for storage may be limited to a certain time period in order to avoid an overload of the storage capacity. This time period may comprise, for example, all of the data fields for the financial messages from the last four weeks. The database for the historic fields may be revised periodically and those data fields older than the given time limit are deleted to efficiently use the resource available. Alternatively running averages (or other statistical calculations) may be kept of the data to reduce the requirements for storage.

The system of the disclosure collects, calculates or otherwise derives its own historical data and is not necessarily dependent on other data sources for collecting the historical data for the historic fields. The system therefore is very flexible and can optimize the representation parameters without the need to agree with the provider of the financial messages (or other data sources) to provide supplementary information. This can save time for generation of the data for the historical fields and thus enable a more efficient and accurate characterisation of the financial messages.

In another exemplary aspect of the present disclosure, the financial messages assigned to a final characterizing category most frequently represented among k neighbouring ones of other ones of the financial transaction data records in the representation space and wherein the confidence value is defined by the fraction of the number of identical ones of the characterizing categories of the k neighbouring ones of the other financial messages.

In another exemplary aspect of the present disclosure the sum of distances between the k nearest neighbours of the financial message being characterized is calculated separately for each one of the characterization parameters categories and the financial data record is assigned to the characterization parameter represented by the shortest sum of distances. The confidence value is defined by at least one of the sum of the shortest distance or a ratio based on the shortest distance.

The data source is at least one of an interface for receiving financial messages or a labelled database comprising data records on the financial messages, including but not limited to financial transactions.

The system for characterizing the financial messages is trained first in a training phase with labelled data from the labelled database. The training phase lasts a finite length of time, which depends on the amount of labelled data in the labelled database and the processing resources available. The system uses the results of the training phase to characterize current financial messages.

The training data comprises data on past financial messages that has been manually analysed (or analysed by another system) and one or more of the characterisation parameters have been allocated to the financial messages in the training data. This is done by scrutinising the financial messages. The result of each scrutinized financial message is stored as a label for the labelled financial messages, so that the label reflects a target characterization parameter that the system ideally should assign during the training phase to a training financial message.

The present disclosure also teaches a method for characterizing the financial messages. One or more of the data items from the financial messages to be characterised are selected and are stored as representation parameters in memory. The method then characterises those financial messages in a subset of the representation parameters by assigning the financial messages in the selected subset of the representation parameters to at least a first characterizing parameter and assigning at least a first confidence value to the at least first characterizing parameter of the financial messages as a result of the characterization. In a further step, the at least first confidence value of the at least one characterisation parameter is compared with a first threshold value, and thereby the financial messages is assigned to the characterisation parameter.

The disclosure also teaches a computer program product stored on a non-transitory computer-usable medium having control logic stored therein for causing a computer to perform the aforementioned method steps.

### BRIEF DESCRIPTION OF THE DRAWINGS

For a more complete understanding of the present invention and the advantages thereof, reference is now made to the following description and the accompanying drawings, in which:

FIG. 1 shows a characterizing system according to the present disclosure.

FIG. 2A shows an overview on the data model used by the enhanced scoring engine.

FIG. 2B shows a set of data models used by the enhanced scoring engine

FIG. 3 shows a detail of the enhanced scoring engine.

FIG. 4 shows a representation space.

FIGS. 5A and 5B show the establishment of a confidence value for one of the algorithms.

FIGS. 6A and 6B illustrate the effect of different data models.

### DETAILED DESCRIPTION OF THE INVENTION

The invention is applicable to systems for characterising various kinds of financial messages, such as but not limited to characterising fraud in card payment transactions, personal loans and home loans, trading, virtual currency and payment related messages including authorization and notification and as well as for the detection of financial crimes such as money laundering, employee fraud and market abuse.

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

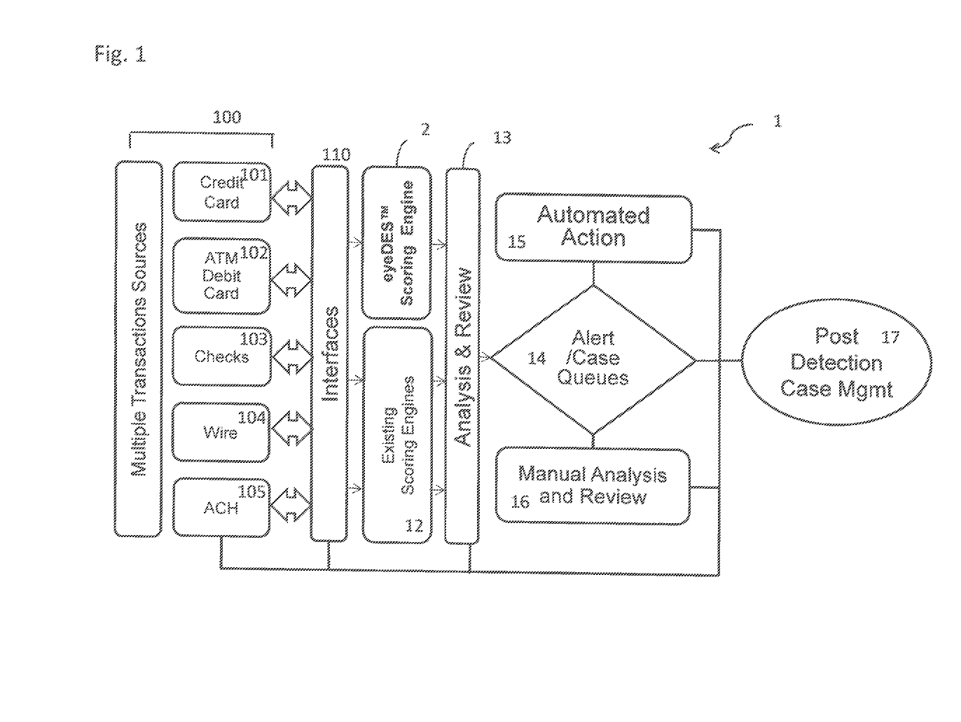

FIG. 1 shows as an aspect of the present disclosure the implementation of the invention in a characterizing system 1 for financial transactions, including but not limited to authorizations of payment card transactions. The characterizing system 1 may be implemented as a computer program on a universal purpose computer or on dedicated hardware. The characterizing system 1 may comprise multiple transaction sources 100 such as, but not limited to credit cards 101, automatic teller machine (ATM) data cards 102, checks 103, wire transfers 104, and automated clearing house (ACH) transactions 105. These transaction sources 100 communicate with the characterizing system 1 via interfaces 110 to transfer data records relating to the financial messages. These interfaces 110 can be provided by dedicated dial in data lines, data transmission over mobile telecommunications networks or communication via the Internet to give three non-limiting examples. Five different transaction sources 101, 102, 103, 104, 105 have been enumerated. The person skilled in the art will appreciate that without limitation to the present disclosure there could be other transaction sources. Alternately the characterizing system 1 may only deal with one transaction source, e.g. the evaluation of credit card authorisations only.

As an example of characterizations of the financial data in the following description, authorisation of the credit card is chosen as the financial message to be characterized. The categories for characterisation may comprise a single category member, labelled for example “fraudulent”, two category members, labelled for example “genuine” and “fraudulent” or more than two category members, for example “genuine”, “fraudulent”, “suspicious”. The person skilled in the art will appreciate that, for other examples of financial messages, the category members may represent and be labelled with other values. For example, it may be necessary to identify those financial messages representing the financial transactions that may represent money laundering and the financial message needs to be characterised to identify those data records possibly relating to money laundering. In this case, one of the category members would be “money laundering transaction”.

In the credit card example, the characterizing of the financial message is generally part of a risk management process. In the event that a client is in a shop and presents a credit card to be charged, it may turn out later that the financial transaction performed, i.e. the payment with the credit card, is fraudulent. This could happen because the credit card presented was stolen and/or an unauthorized person is using the credit card to acquire goods or services in the shop.

In the event of approval of the credit card payment (financial transaction) by the card payment system, the entity approving the credit card transaction may have to bear the costs of approval and may not be reimbursed for the (fraudulent) credit card transaction. The card payment system (or a financial institution issuing the credit card system has therefore an interest in identifying the fraudulent financial transaction, represented by the financial message. On the other hand, in case of rejection of too many financial transactions because of a perceived risk, although the financial transaction was a genuine transaction, e.g. the real holder uses the credit card, the entity (as well as the shop) may lose turnover and may also lose honest clients. The honest clients are unwilling to accept too many rejections of use of the credit card and might switch to another credit card issued by a competitor financial institution.

The interface 110 for receiving requests from the different transaction sources 101, 102, 103, 104, 105 can pre-process the incoming data records, for example by transforming different data formats used by the different transaction sources 101, 102, 103, 104, 105 into a common data format for further processing.

For card-based transactions there is, for example, an ISO norm (ISO 8583) that defines a message format and a communication flow for the data records representing the financial messages relating to the financial transactions so that different financial systems can exchange transaction requests and responses. Typically the transaction request travels from a transaction-acquiring device, such as a point-of-sale terminal or an automated teller machine (ATM), through a series of switching networks, to the characterizing system 1 for authorization of the financial transaction against the cardholder's account. The data record for the financial message contains information derived from the card (e.g., an account number), a terminal (e.g., a merchant number), a transaction (e.g., an amount), together with other data items generated dynamically by the transaction-acquiring device or added by intervening systems. The characterizing system 1 will characterise the financial message either “authorize” or “decline” and generate a response message. The response message must be delivered back to the transaction-acquiring device within a predefined time period. The ISO Standard No. 8583 is not an exclusively used format and other proprietary or region-specific formats exist in parallel to the ISO Standard No. 8583. The response message may include an explanation or some form of reasoning to explain why the financial message was so characterised.

The interface 110 forwards the pre-processed data record representing the financial transaction to an enhanced scoring engine 2. The interface 110 may additionally forward the pre-processed data to one or more scoring engines 12, for example prior art scoring engines, although the enhanced scoring engine 2 of this disclosure once trained and put into operation may render the other scoring engines 12 obsolete. The enhanced scoring engine 2 uses at least one data model and assigns a characterisation category to the data record as well as a confidence value and, if appropriate, a reasoning to the data record. The confidence value reflects the confidence that the characterisation value is correct and the reasoning gives an explanation as to why the classification category was assigned. More details of the reasoning will be given below.

The output of the enhanced scoring engine 2 and, if applicable, the output of the other scoring engines 12 is forwarded to an analysis engine 13. The analysis engine 13 reviews the characterisation value and confidence level and passes the information with the data record and reasoning to either an automatic action decider 15 and/or to a manual review process 16 through a queue 14. The automatic decider 15 can decide in substantially real time whether to accept or reject the credit card transaction and sends back a routing response (not shown in FIG. 1) to the requesting one of the transactions sources 101, 102, 103, 104, 105 “transaction approved” or “transaction rejected”.

In some cases, such as when no clear score is available as to whether the financial transaction is a genuine financial transaction or a fraudulent financial transaction, and/or the amount of the transaction is comparatively high, the analysis engine 13 may decide to forward the information including the characterisation category, the reasoning and the confidence level additionally or instead to the manual analysis and review process 16. The information is queued in the queue 14 before analysis. The analysis engine 13 can be programmed to adapt the length of the queue 14 to the number of human analysts available to process the data records in the manual analysis and review process 16. Optionally data records from specific financial transactions may be collected and forwarded to a post detection case management system 17 for later review and analysis.

The post detection case management system 17 is an external system for handling fraud alerts, manually inspecting, investigating and decisioning financial messages to improve the enhanced score engine 2. The post detection case management system 17 can also employ enhanced automated security measures.

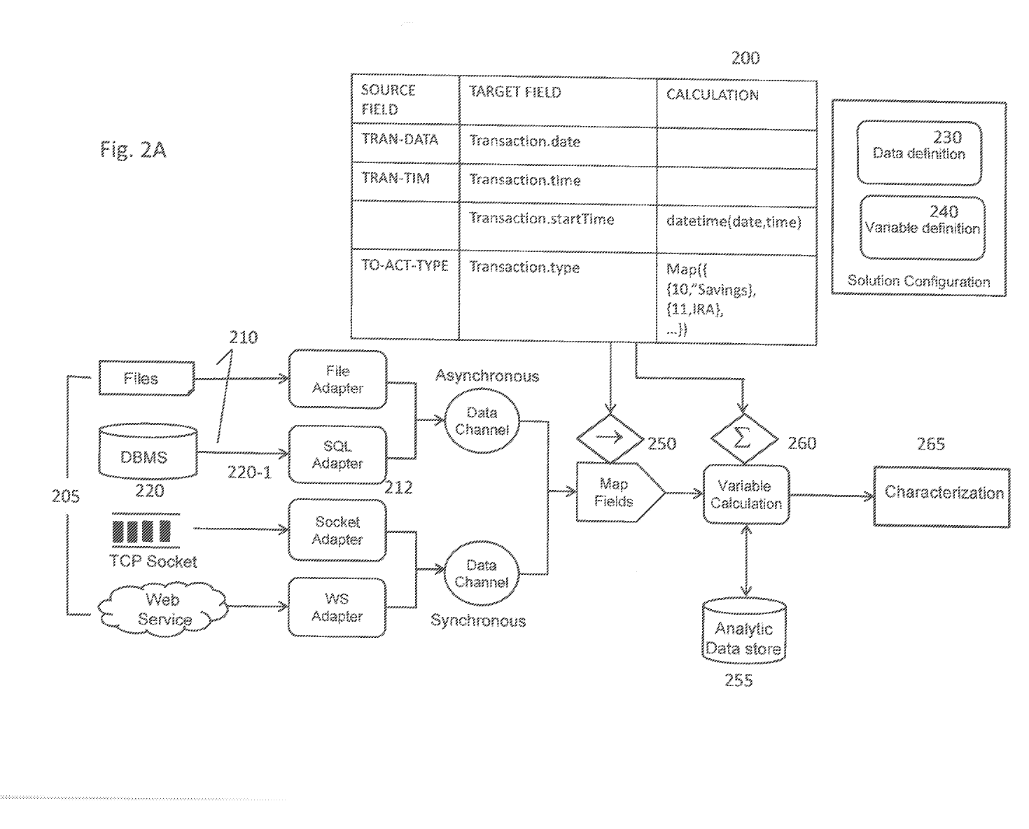

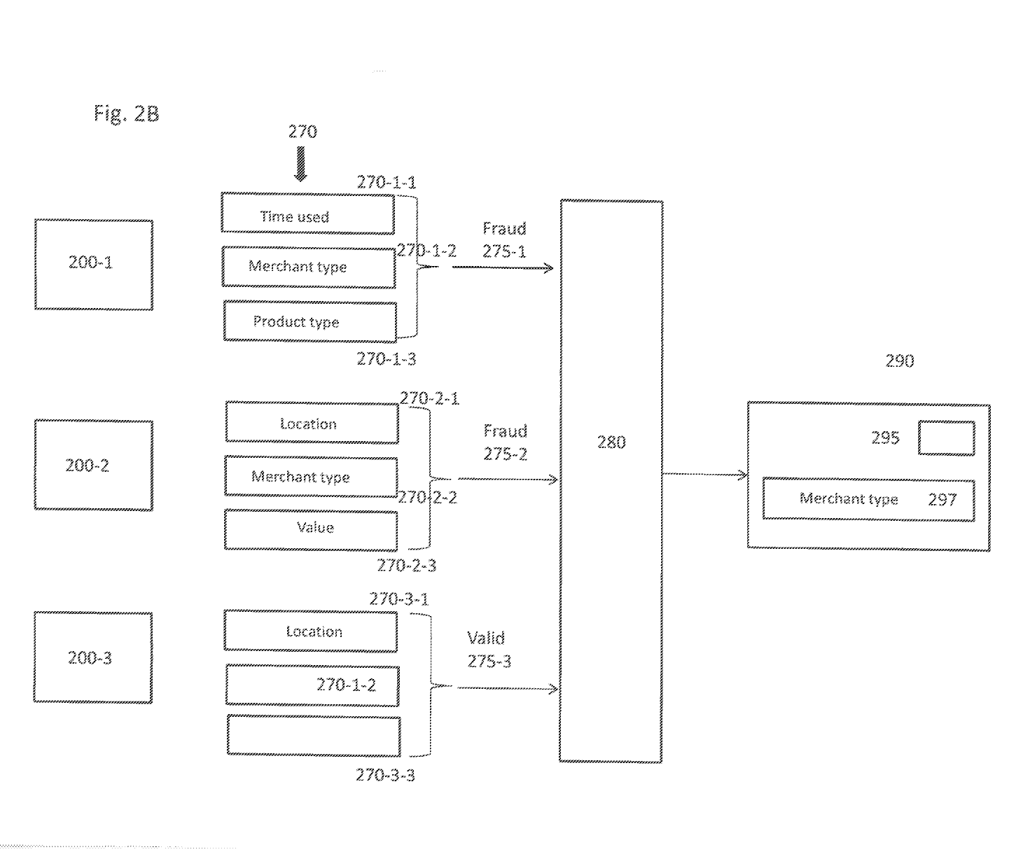

The enhanced scoring engine 2 uses different data sources 205 as input for the statistical pattern recognition. An overview of the data model 200 of the enhanced scoring engine 2 is shown in FIG. 2A. The term “current transaction data” means in this context the data records relating to the financial message that is transmitted to the characterizing system 1 for characterisation. As noted above, the format of the current transaction data records may use several different formats, including but not limited to ISO8583 messages over TCP sockets or XML messages over a message queue.

The current transaction data record comprises, for example, the encrypted credit card number, the transaction amount, the amount, the requesting merchant identifier, time of the financial transaction and other data. The components of the current transaction data records are mapped in a mapping engine 250 to input fields, such as but not limited to CARD_NUMBER for the credit card number, AMOUNT for the transaction amount to be approved, and MERCHANT_ID for the identification parameter for identifying the requesting merchant. The definitions and mappings are stored in a data definition repository 230. The mapping engine has access to the data definition repository 230.

The enhanced scoring engine 2 also has access to other databases with static data. The term “static data” means in this context the kind of data in general is valid for a longer period of time. This definition does not exclude a change in the static data from time to time, whenever appropriate. The static data may comprise, for example, the information of data on the credit card owner, such as the postal/ZIP code of the place of domicile (stored in a parameter CARD_OWNERZIPSODE) or the date of birth (stored in a parameter CARD_OWNER_BIRTH_DATE). This static data can be retrieved from the parameter CARD_NUMBER of the data record of the financial message in the request. The static data may further relate to the credit card acceptance partner, such as the location (stored in a parameter LOCATION_OF_REQUEST) and the kind of business (food store, rental car, hotel, restaurant, car dealer, mail order, etc.) stored in a parameter MCC (the abbreviation of merchant category code). This data may be retrieved from the parameter MERCHANT_ID obtained from an authorisation request for a payment card.

The enhanced scoring engine 2 can store in one aspect of the invention running statistics on certain parameters of the financial messages. It would also be possible to store a history of requests for each one of the credits of other payment cards used. Such storage will expand over time and thus it may be preferable to only maintain running statistics to reduce the amount of storage required. For practical reasons due to the limited amount of storage available, the set of historic data may be stored for a limited period of time only, e.g. for five days or four weeks. Periodically the data items forming the historic data that are older than the time limit will be deleted from the set of historic data. The data items in the historic data may come from different data sources and corresponding ones of the interfaces 210 have to be provided. For example, a first interface 210-1 connects the enhanced scoring engine 12 with a database 220 of the credit card issuing financial institution to retrieve information from the credit card issuing financial institution and map the retrieved information to corresponding internal parameters. A SQL adapter 212 is used to interrogate the database 220. The mapping is carried out in the mapping engine 250.

A data scientist configures the enhanced scoring engine 2 by constructing at least one data model 200. The enhanced scoring engine 12 is designed such that the data scientist can create derived fields used in the data model 200 that are based on the input fields as well as historic data and/or combinations thereof The historic data is stored in an analytic data store 255. The data scientist may define, for example, a numerical derived field NUMBER_OF_TRANSACTION_REQUESTS that counts how many credit card transaction requests have been received in the last thirty days from the same credit card. Another numerical derived field would be AMOUNT_OF_TRANSACTION_REQUESTS, which represents the accumulated value of the received credit card transaction requests over the last thirty days from a particular merchant. A derived field with a logical value could be NUMBER_OF_TRANSACTIONS_GREATER_{—}9, which would be set to logical TRUE in the event more than 9 transactions have been approved within a defined time period from the same credit card number. These definitions of the derived fields will be stored in the variable definition 240.

It will be appreciated that these are only exemplary derived fields that can be calculated. The enhanced scoring engine 2 provides the possibility to create further types of derived fields. It is the data scientist's responsibility to search for and develop the most appropriate derived fields and to provide the appropriate input fields and/or derived fields for use in the characterization of the financial messages. These derived fields are developed and stored in the variable definition repository 240. The choice of the most appropriate input fields and/or derived fields is a matter of experience of the data scientist and will generally be kept confidential. The derived fields are calculated in a variable calculator 260

It is known that fraudsters adapt their behaviour. The data scientist may review from time to time the input fields and/or the derived fields. The data scientist can create new ones of the derived fields or use alternative ones of the input fields in order to overcome any identified weaknesses or to improve the characterisation process. The data scientist may, for example, decide that a derived field based on historic data (termed GAS_STATION_PER_WEEK that counts the number of time of use of the credit card for payment in gas stations within the last week) would be helpful to indicate an increased risk, as consumer statistics show that the average private person usually does not have to fill up his or her car every day.

A characterisation calculator 265 is used to determine the characterisation of the financial records from the incoming financial transaction, the data model 200 and other data.

In one aspect of the invention, the enhanced scoring engine 2 may comprise a plurality of the data models 200 created by the data scientist. The different ones of the data models 200 can use different combinations of input fields and/or derived fields or can use different derived fields to characterise the financial transactions. For example FIG. 2b shows three different ones of the data models 200-1, 200-2 and 200-3. It will be appreciated that there will be in practice many more of the data models 200 in use. Each one of the data models 200-1, 200-2, 200-3 uses three input variables collectively denominated 270. The output 275-1, 275-2, 275-3 of the data models 200-1, 200-2 and 200-3 represents the characterising parameter for each one of the data records fed into each one of the data models 200-1, 200-2 and 200-3. In a very simple solution, a final characterisation parameter 290 of the enhanced scoring engine 12 will be formed from a majority vote based on the outputs 275-1, 275-2, 275-3 of each of the plurality of data models 200-1, 200-2 and 200-3. So, for example, if two of the data models 200-1 and 200-2 indicate that the financial transaction represented by the financial data record is fraudulent and the third one of the data models 200-3, on the other hand, indicates that the financial transaction is genuine, then the majority vote in a voting unit 280 will indicate that the financial data record is fraudulent.

The example of FIG. 2b also indicates that a confidence value 295 can be attached to the output of the data model 200. In this case, the confidence value 295 could be ⅔ since ⅔ of the plurality of data models 200-1, 200-2 and 200-3 indicate that the financial transaction is fraudulent.

The enhanced scoring engine 2 can also create a reasoning in order to indicate the reasons why a particular one of the financial messages was characterized. The concept of reasoning is based upon a so-called local importance of the fields used in characterizing the current financial transaction. The concept of the local importance is different than the global importance. The global importance indicates the general (sort of “average”) importance of the fields with respect to the classifier. The local importance indicates the relevance of the fields in producing the final decision.

One illustrative example of the reasoning used can be understood by considering a data model 200, which is a random forest (decision tree) algorithm model.

This model is based on counting the appearance of each field (from the financial message data) in the voting process of the binary tree. In this example of the random forest algorithm model, the binary tree nodes of the data model each contain two items: the field that must be tested at that binary tree node, and a threshold value associated with that binary tree node. If the field at that binary tree node has a value that is greater than the threshold value, the right branch is selected, otherwise the left branch is selected (the terms right and left are merely used to distinguish one branch from the other branch and have no directional meaning).

An execution of the data model 200 continues through the binary tree nodes until a so-called leaf is reached. The label of the leaf indicates the tree's vote: Fraudulent or Genuine. The path from a root of the binary tree (i.e. the input) to that leaf is called “decision path”.

The method of generating the reasoning comprises two processes: selecting the most relevant fields for the vote, and ranking the selected fields according to their importance.

Not all of the fields in the decision path are created equal. The relative importance of each one of the variables is based on two separate criteria that order the fields in 2 different ways:

Absolute Fraud Voting

Relative Fraud/Genuine Voting

The first method is for absolute fraud voting and one counts the number of appearances for each of the fields across all of the decision paths and puts the number of appearances into a vector (1D array). In practice, the appearances of the fields will not count equally. If the field appears in the root of the binary decision tree, it will count as 1 (i.e. be weighted as 1). If the fields appears in the binary tree node at the second level, the appearance will count as (1.3)⁻¹. On the third level, the appearance will count as (1.3)⁻². The weight associated with each one of the binary tree nodes is therefore (1.3)-^{-L}, where L is the level on which the binary tree node resides inside a tree and along the decision path. The fields from the decision path are only counted only if the decision path ends with the leaf having a ‘Fraud’ label. In other words, this procedure is only counting those fields used in determining that the financial transaction is fraudulent. The weighting of the count of the appearances gives a higher weight for those nearest to the leaf The field that appears most often will be considered most important field in making the characterization that the financial message evaluated is fraudulent, and can be output as the reasoning.

A similar process takes place in the case of relative fraud/genuine voting. Here, two separate field counts are performed in the same manner described above (and weighted by the node levels). One of the field counts is for the ‘Fraud’ decisions, and the other of the field counts for the ‘Genuine’ decisions (i.e. leaf at the end of the decision tree is labelled “Genuine”). The ordering of the fields is based on the NF/NG ratio for each of the parameters. NF is the (weighted) number of appearances of the field in ‘Fraud’ decisions, and NG is the (weighted) number of appearances of the field in ‘Genuine’ decisions. Additionally, after being calculated, NF is weighted by a “compensation” factor K.

The purpose of the compensation value K is to compensate for the fact that the number of the decision trees used in the calculation of “fraud” decisions is smaller than the number of decision trees used in the calculation of “genuine” decisions. The value of the compensation factor K will be calculated as follows. Suppose that there are 150 decision trees (=NF+NG) and only 39 (=NF) of the decision trees are used to flag the “fraud” decision, then K will be equal to 111/39 (111 being 150−39). It will be appreciated that this is only an example and other numbers of decision trees could be used.

In a similar manner to the absolute fraud vote counting, for a subset of the variables in the genuine vote counting, these are counted only if they are less or equal to the threshold from the respective node. The final ordering of the fields is done again in descending order. In practice, in order to avoid divisions by zero, we use the (1+K*NF)/(1+NG) ratio instead of K*NF/NG.

In both methods the fields will be ranked with the sorted vector ranging from 1 (most important variable) to N (least important one). The final ranking of each field will be the average of the two rankings, followed by a reordering of the resulting ranking values in ascending order. This will give the fields with the topmost ranking values

The list of ranked fields is pruned and only the following fields are selected for output with the reasoning:

Fields which have values (i.e. we discard fields whose values are null or are otherwise missing from the transaction data);

Fields which appear at least once in the decision paths;

Fields whose Absolute Fraud Voting count multiplied by the compensation factor K is greater than the Absolute Genuine Voting count.

Furthermore, in the case of absolute fraud voting, only those fields are kept whose (weighted) count of appearances is greater than the median value across all (weighted) fields counts. The median is calculated only across the fields that remained after the pruning described above.

In the case of the relative fraud/genuine voting, only the fields are kept whose ratio (1+K*NF)/(1+NG) is greater than the median across all of the fields ratios. The median is also calculated only across the fields that remained after the pruning

Finally only the fields resulting from the union of the two selection processes above and, more specifically, we take the top X fields out of these remaining fields.

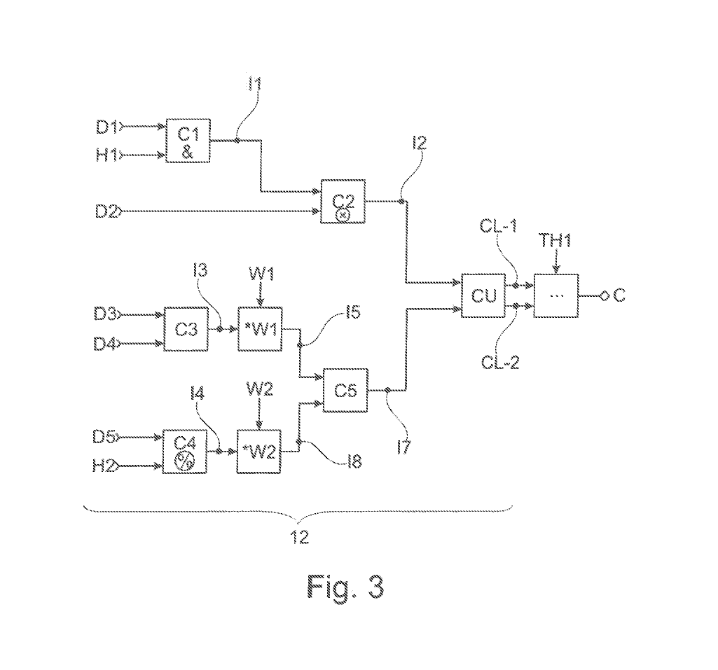

FIG. 3 shows by means of a flow chart the training steps for the enhanced scoring engine 2. In a training mode a labelled database 31 with training data records including input fields and associated characterisation parameters is used as input data to the enhanced scoring engine 2, instead of current financial messages. The data records of the training data in the labelled data base 31 corresponds to real items of transaction messages in which a final characterisation could be attributed to the data record relating to the financial messages. In this example, the characterisation related to financial messages representing a genuine financial transaction or a fraudulent financial transaction. For example, the training data may result from those financial transactions that were characterized as fraudulent and have been analysed in the post detection process 17 by a fraud analyst. Thus it is possible to attribute to each of the data records of the training database a score derived from the data items of the financial data record and thus determine a characterizing parameter “genuine” or “fraudulent” as a label. Apart from the label, the data record in the training set and the data record of a real financial message have an identical structure.

In an initial step 32 the enhanced scoring engine 12 is presented with all of the input fields, e.g. data that is presented as is, without being modified. In the present disclosure the input fields comprises the fields corresponding to the data items of the financial message as well as the static data. Typically for credit card fraud estimation approximately 80 fields representing these three types of data are available. The person skilled in the art will understand that the exact number of the input fields depends on a specific implementation and also other numbers of the fields are conceivable.

In the course of the training the data scientist may create the so-called “derived fields”. These are parameters that are logical or numerical combinations or mathematical transformations of some of the input fields from the input data, the static data and/or the historic data. The derived fields may comprise a weighted combination, a mathematical operation on one of the fields or a logical combination of at least two fields or may comprise statistical calculations on several ones of the fields. The statistical calculations include, but are not limited to, determining the mean value or variance of a set of fields in the direct data as well as maintaining running averages.

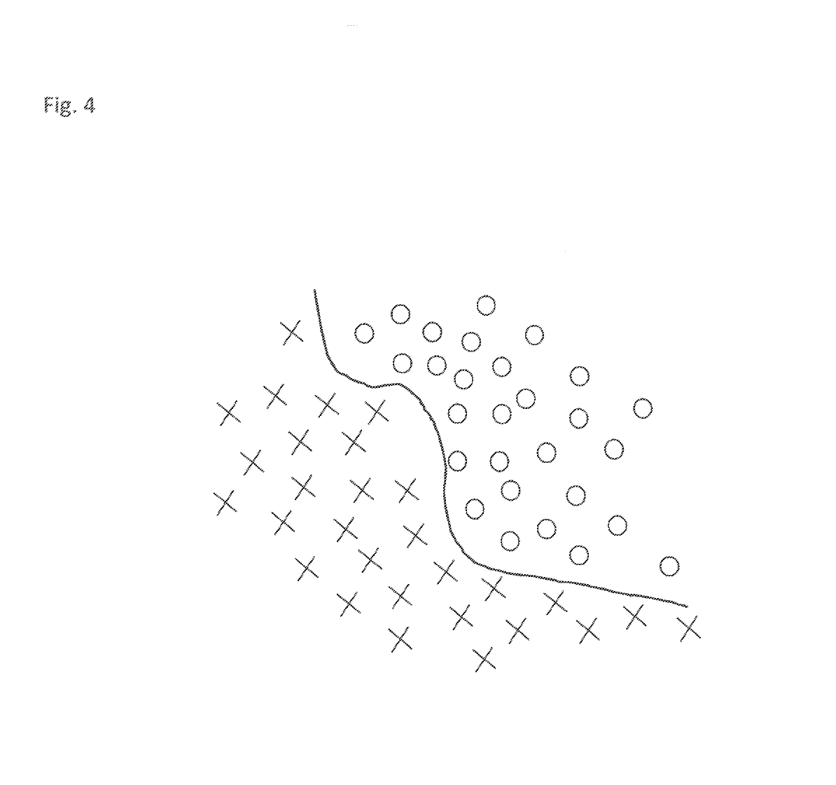

This is illustrated graphically in FIG. 3 and described in the following non-limiting example. A first, a second, a third, a fourth and a fifth input field D1, D2, D3, D4, D5 and a first and a second historical field H1, H2 based on the historical data have been chosen to demonstrate the principle of the enhanced scoring engine 12 and the analysis engine 13. As already pointed out earlier it is the task of the data scientist to find the appropriate rules and select the fields to generate a representation space in which the financial transactions may be represented. The representation space is a multi-dimensional space and is shown in representatively in two dimensions in FIG. 4.

In the example shown in FIG. 3 the first input field D1 is a first input field of a first data combiner C1 and the first historical field H1 is a second input field of the first data combiner C1. The first direct field D1 and the first historical field H1 are combined in the first data combiner C1 to produce a first derived field I1. In this example the first input field D1 and the first historical field H1 are both logical data. Therefore the first data combiner C1 in this example is equivalent to an AND-function. The result of the first combiner C1 is therefore also a logical parameter having either a value of zero in case the logical state of the first derived field I1 is “false” and a value of one in case the logical state of the first derived field I1 is “true”. The first derived field I1 is input as a third input value to a second combiner C2.

The second input field D2 is input as a fourth input value to the second combiner C2. In this example the second input field D2 is a number. The second combiner C2 multiplies the value of the first derived field I1 with the value of the third input field D3 and thus produces as a result a second derived field I2. In case the first input field I1 represents the logical value “false” the value of the second derived field 12 will be zero for any value of the third input field D3. In case the logical value of the first derived field I1 is “true” the second derived field I2 will be identical to the value of the third derived field D3.

The third derived field D3 and the fourth derived field D4 are combined in a third combiner C3. In this example the third combiner C3 is an adder that adds the values of the third derived field D3 to the fourth derived field D4. The result of this summation is a third derived field I3.

The fifth input derived field M5 and the second historical field H2 are combined in a fourth combiner C4. In this example the fourth combiner C4 is a divider that calculates the ratio between the historical field H2 and the fifth input field D5. The result is a fourth derived field 14.

The first combiner C1, the second combiner C2, the third combiner C3, and the fourth combiner C4 are merely examples. In an application of the enhanced score engine 2 the data scientist may choose from a variety of mathematical or logical functions to calculate the derived fields from the input fields and the historical fields, as well as other derived fields. These mathematical or logical functions may include but are not limited to logarithmic and exponential functions, average functions, and statistical parameters such as the standard deviation.

The third derived field I3 is weighted, i.e. is multiplied with a weighting factor W1 resulting in a fifth derived field I5. The fourth derived field I4 is weighted, i.e. is multiplied with a second weighting factor W2 resulting in a sixth derived field i6. The fifth derived field I5 and the sixth derived field 16 are input to a fifth combiner C5. In this example the fifth combiner C5 adds the fifth derived field I5 and the sixth derived field 16 producing as a seventh derived field I7.

The second derived field I2 and the seventh derived field I7 are input to the characterization unit CU. The characterisation unit CU will calculate a score for the financial message and, based on the score, the characterisation unit CU will assign the appropriate characterisation parameter. It will be appreciated that the characterisation unit

CU will have a variety of other input fields. In the following example only two fields are chosen as representative fields as a two-dimensional space is easily represented. In practice, a number of fields are chosen as inputs for the characterisation unit.

Not all of the financial messages from the training set will be used to create the data model 200. In an exemplary system, around 80% of the financial messages are used. The remaining 20% of the financial transaction data records can be used to test the data model 200. It will be appreciated that the 80/20 division can be varied as required and is not limiting of the invention.

FIG. 4 shows a two-dimensional projection of the N-dimensional representation space in which the financial messages with a first label are shown as crosses and data labels with a second label are shown as circles. The positions in the projected two dimensional representation space are indicative of the score of the financial data record. The crosses for example may indicate financial messages characterised as fraudulent transactions and the circles for example may indicate financial messages characterised as genuine transactions. It can be seen that the financial data records that are fraudulent are gathered in one section of the projected characterising space and the financial data records the financial data records, which are genuine, are gathered in another section of the projected characterising space.

The data scientist can develop a number of different data models during the training phase and can choose those data models 200 that give the best scoring results. Examples for the data models 200 include, but are not limited to, a linear classifier, a quadrant classifier, a decision tree classifier, and a support vector machine. In case of a distribution as depicted in FIG. 4 a linear classification model could be the appropriate choice. It is possible that the data scientist may develop multiple characterisation models that can be used for different purposes, as shown in FIG. 2b.

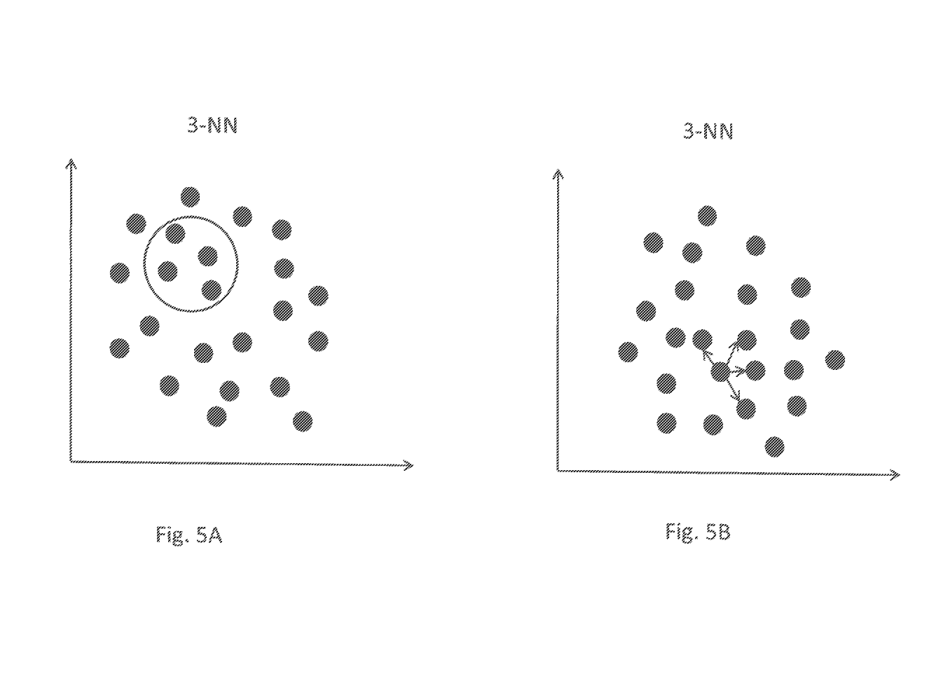

FIG. 5A shows how an exemplary embodiment for the calculation of a confidence value for the characterisation parameter for a selected one of the financial messages. The selected financial message and its neighbours in the representation space have been characterized by the characterization unit CU. The k-nearest neighbours of the selected financial message in the characterization space are selected. The term “nearest neighbour” in this context means the Euclidian distance between the coordinates of the financial message and the coordinates of each of the other financial messages in the characterization space enclosed by a circle about the selected financial message.

The circle in FIG. 5A is for illustration only and the radius has been chosen to include the 3 nearest neighbours based on their score to the selected financial message. It will be appreciated that in three dimensions the nearest neighbours within a sphere will be counted. Within the circle, one financial message is characterized in a first characterisation parameter (blue) and two financial messages are characterized in a second characterisation parameter (red). Thus the confidence value of the selected financial message having the second characterisation parameter will be higher than the confidence value of the selected financial message having the first characterisation parameter.

FIG. 5B shows as a second exemplary example in which the confidence value is calculated. A first distance dl between the selected financial message and a closest neighbour, a second distance d2 between the selected financial message to a second closest neighbour, and a third distance d3 between the selected financial message to a third-closest neighbour are calculated. The sum of the distances of the 3-closest neighbours that have the same characterisation parameter as the selected financial message is divided by the sum of all k-nearest neighbours to provide the confidence value. The confidence value is thus in a range between 0 and 1 or in percentage points between 0% and 100%. The person skilled in the art will appreciate that the distances may be weighted before the ratio is calculated.

The confidence value can be used to improve characterisation of the financial messages. Those financial data records having a high confidence value can be assumed to be correctly characterised. A confidence value threshold can be set by the data scientist. Those financial messages in which the confidence value is lesser than the confidence value threshold can then be checked more carefully. The data scientist can chose the level at which to set a threshold level for the confidence value threshold. One purpose for changing the confidence value threshold would be to enable the manual analysis and review method 16 to optimise the number of financial messages awaiting analysis and review in the queue 14. For example, when fewer of the fraud analysts are available only those financial data records with a low confidence value would be checked.

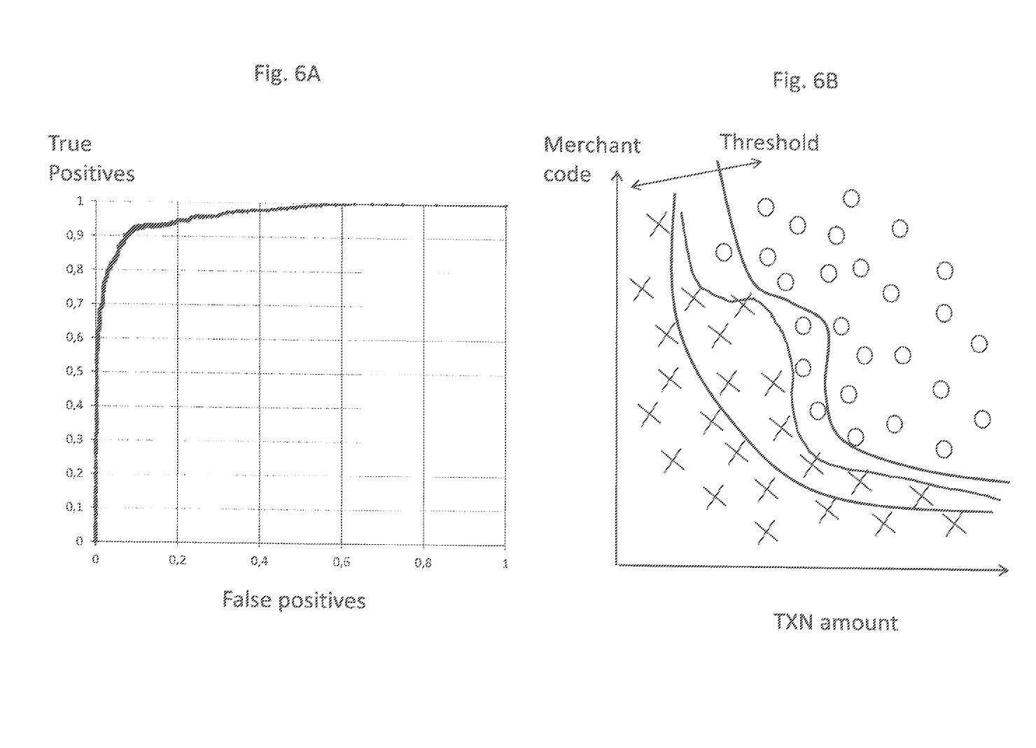

In a further aspect of the invention, it is possible to produce a set of the data models 200 which can be changed from time to time and/or on the fly. The advantage of this can be seen from FIGS. 6A and 6B. FIG. 6A shows a simple curve in which it is shown that each one of the sets of data models 200 produces a certain number of true positives and a certain number of false positives. The x marks the results of each of one of the data models 200. In other words, each one of the sets of data models 200 will produce both correct characterisations (in which the financial message has been characterised correctly, i.e. true positives and true negatives) and incorrect characterisations (false positives and false negatives).

The particular one(s) of the set of data models 200 chosen can be used to adjust the number of financial messages that need to be reviewed manually, i.e. a larger number of alerts. So, for example, by moving up the curve it is likely that a larger number of false positives in the alerts are present and thus more financial messages have to be analysed. This will require a larger number of fraud analysts as well as additional memory space in the system. On the other hand a significant larger number of these data records have been characterised correctly and thus there would have been no need to look at the financial messages in detail and storage space as well as fraud analysts' time could have been saved. In such a case, the system is likely to catch more fraudulent financial messages, but also generate more incorrect characterisations in the form of false positives (i.e. financial records which are characterised as being fraudulent, but are in fact genuine). The balance for false positives is the numbers of frauds caught, or the total loss prevented. If more alerts are allowed, the system will ‘play it safe’, score higher and thus will both catch more fraud and generate more false positives. A balance also needs to be drawn based on available capacity in the system.

This aspect of the invention enables a change of the set of data models 200 being employed to cope with the resources available. FIG. 6B shows a two dimensional representation of the data model 200 in which it can be seen that the set of the data models 200 produce different results. The x-axis shows additionally the transaction amount (TXN amount) that indicates that one can “slide” the threshold values shown as lines to optimise also those ones of the data models 200 that produces better results for larger transaction amounts. It is possible to select the appropriate one of the data models 200 at the beginning of the method, or possibly to dynamically change the data model during the analysis. While various embodiments of the present invention have been described above, it should be understood that they have been presented by way of example, and not limitation. It will be apparent to persons skilled in the relevant arts that various changes in form and detail can be made therein without departing from the scope of the invention. Thus, the present invention should not be limited by any of the above-described exemplary embodiments, but should be defined only in accordance with the following claims and their equivalents.

1. A characterizing system for characterizing financial messages, the financial messages comprising a plurality of input fields, and for assigning a financial message to at least one characterisation parameter, the characterizing system comprising:
at least one data source providing the financial messages to a data integration unit, wherein the data integration unit is adapted to select one or more of the plurality of data items of the financial data record and for storing the selected data items as representation parameters in memory; and
at least one characterization unit running a data model for characterising a subset of representation parameters by assigning the selected subset of representation parameters to at least a first characterization parameter and assigning at least a first confidence value to the at least a first characterization parameter.

2. The characterizing system of claim 1, further comprising at least one decision unit for comparing the first confidence value with a first threshold value and assigning the financial messages to a characterisation parameter as a result of the comparison.

3. The characterizing system of claim 1, further comprising a plurality of characterisation units and associated data models.

4. The characterizing system of claim 3, wherein the data model and associated characterisation can be replaced while the system is running.

5. The characterizing system of claim 1, wherein the characterisation unit can further produce a reasoning for each financial transaction.

6. The characterizing system of claim 1, further comprising a data-enhancing unit for creating derived fields as a result of one of a mathematical operation or a logical operation applied to at least one input field.

7. The characterizing system according to claim 6, wherein the data enhancing unit stores a plurality of historic data and wherein the data enhancing unit creates a historic representation parameter as a compound parameter, based on the stored plurality of historic data.

8. The characterizing system according to claim 1, wherein the at least one data source is at least one of an interface for receiving financial messages or a labelled database comprising data records on financial transactions.

9. A method for characterizing financial messages from an input source, the financial messages comprising a plurality of input fields and for assigning the financial message to at least one characterisation parameter, the method comprising:
selecting input fields of the financial messages;
storing the selected input fields or a combination of the selected input fields as representation parameters in memory;
characterizing, using at least one of a plurality of data models with an associated characterisation unit, a subset of the representation parameters by assigning the financial messages in the selected subset of representation parameter to at least a first characterisation parameter; and
assigning at least a first confidence value to the at least first characterizing parameter of the financial messages as a result of the characterizing.

10. The method of claim 9, further comprising comparing the at least first confidence value of the at least one characterizing parameter with a first threshold value, and thereby assigning the financial messages to the characterising parameter.

11. The method according to claim 9, further comprising creating derived fields by selecting two or more input fields and calculating a combination of the selected input fields.

12. The method according to claim 9, further comprising developing the plurality of data models using a training set.

13. The method of claim 9, further comprising:
selecting input fields from a data source;
storing the selected input fields as historic data; and
creating a historic field based on the historic data.

14. The method of claim 9, further comprising creating a plurality of characterisation parameters; and voting from among the plurality of characterisation parameters to define a final characterisation parameter.

15. A computer program product comprising a non-transitory computer-usable medium having control logic stored therein for causing a computer to perform a method for characterizing financial messages from an input source, the financial messages comprising a plurality of input fields and for assigning the financial message to at least one characterisation parameter, wherein the stored control logic comprises:
a first logic for selecting input fields of the financial messages;
a second logic for storing the selected input fields or a combination of the selected input fields as representation parameters in memory;
a third logic for characterizing, using at least one of a plurality of data models with an associated characterisation unit, a subset of the representation parameters by assigning the financial messages in the selected subset of representation parameter to at least a first characterisation parameter; and
a fourth logic for assigning at least a first confidence value to the at least first characterizing parameter of the financial messages as a result of the characterizing.
